(19) United States
(12) Patent Application Publication
(10) Pub. No.: US 2004/0245677 A1
(43) Pub. Date: Dec. 9, 2004

(54) UV cure resin molding method

(76) Inventors: Melvyn G. Marple, Watertown, CT (US); Scott Byerley Lowder, Orange, CT (US)

Correspondence Address: ST. ONGE STEWARD JOHNSTON & REENS, LLC, 986 BEDFORD STREET, STAMFORD, CT, 06905-5619, US

(21) Appl. No.: 10/456,021

(22) Filed: Jun. 6, 2003

(51) Int. Cl. B29C 35/08

(52) U.S. Cl. 264/496; 264/334; 425/174.4

(57) ABSTRACT

A method of manufacturing consumer products such as cosmetic packages has the steps of providing a mold or die, filling the mold or die with a UV curable material, and exposing the UV curable material to a UV light source to cure said UV curable material to a solid mass.

### FIELD OF THE INVENTION

The present invention relates to a method for manufacturing plastic resin components. More specifically, this invention relates to a method of molding plastic resins using ultraviolet (“UV”) cure technology.

### BACKGROUND OF THE INVENTION

Traditional molding methods involve injection molding and extrusion methods where a polymer is heated to a plastic state, then formed in a mold or die, then cooled to form a finished product. As such, the mold must be made from a substrate that is able to withstand these pressure and temperature changes. Often, molds are made of high strength steels and are expensive to produce. There remains a need for an efficient molding method with fewer production steps and reduced time for forming the finished product. The mold or die should be produced from a wider array of substrates to reduce costs and increase versatility of mold designs.

UV cure technology is used in both industrial and decorative applications. The technology involves a photopolymerization process that fuses resin molecules together to form molecular chains. UV curing is widely used in paints, inks and varnishes. UV cure coatings are often used to provide scratch-resistance and durability to the surface of products such as digital versatile discs (DVDs), golf balls, and guitar bodies, providing a smooth, attractive appearance to these products. UV cure adhesives and sealants are also widely used. They provide quick bonding due to their ability to cure rapidly, in seconds, with a clear, colorless appearance. The viscosity of the UV cure adhesive can be varied depending upon the application. They provide a strong durable bond for a wide variety of substrates, including glass, plastics, wood, ceramics and paper. The UV cure process produces strong durable bonds in seconds without the use of solvents, providing an efficient and environmentally-friendly. Further, cationic adhesives that have been developed continue to cure after the light source is removed providing an even greater finished cure strength.

While UV curing systems have been used in coatings and other applications permitting UV light irradiation of coated surfaces, UV curing systems have not been heretofore used in other applications, in particular, have not been known to be used in connection with cavity molding methods.

### SUMMARY OF THE INVENTION

It is an object of the invention to provide a method and system for manufacturing molded articles using UV curing systems. It is an object of the invention to provide substantial improvements in manufacturing molded articles, including elimination of heating and cooling of molds as is typically required of injection molding methods; decreasing energy consumption; reducing molding pressures; allowing use of lower cost mold materials; reducing material waste; and providing greater manufacturing flexibility.

While UV cure resins have been used to form coatings and adhesives, they have not generally been used in molding applications. UV cure technology is an efficient means of molding materials as it involves low energy consumption. Productivity is improved as exposure to mere seconds of UV light initiates cure. Unlike other molding processes, UV cure technology is environmentally-friendly as it does not require use solvents. It does not require the heating and cooling or applying pressure to mold the material. This results in a minimal cavity space and increased gate size. As temperature is controlled, molds may be made from a wider variety of substrates, including heat sensitive materials, and is not limited to high strength steels. Additionally, there is no shrinking, warping or occurrence of voids as in traditional molding processes. Therefore, molding of UV curable material is ideal for manufacturing articles or components of an aesthetic nature.

A method of manufacturing molded articles in accordance with the invention comprises providing a mold or die at least substantially enclosing a cavity therein, filling the mold or die with a UV curable material, and exposing the UV curable material to a UV light source of a sufficient intensity and for a sufficient time to cure said UV curable material to a solid mass contained in said mold or die. In preferred embodiments, the mold is formed of a plurality of mold segments that can be fitted together to form the mold and separated from each other to release a manufactured product from the mold. The UV curable material is exposed to the UV light source either through an opening in the top of the mold or through UV transparent ports, panels or portions of the mold. In one embodiment, the entire mold may be UV transparent. The UV light may be directed at the UV curable material through one or more such ports.

Other objects, aspects and features of the present invention in addition to those mentioned above will be pointed out in or will be understood from the following detailed description provided in conjunction with the accompanying drawings.

### BRIEF DESCRIPTION OF THE DRAWINGS

FIG. 1 is a side elevation cross-sectional view of an embodiment of a mold for use in the method of the invention.

FIG. 2 is a side elevation cross-sectional view of a second embodiment of a mold for use in the method of the invention.

FIG. 3 is a side elevation cross-sectional view of a third embodiment of a mold for use in the method of the invention.

FIG. 4 is a top plan view of a system in accordance with an embodiment of the method of the invention.

FIG. 5 is a schematic view of an extension system in accordance with another embodiment of the method of the invention.

### DETAILED DESCRIPTION OF THE DRAWINGS

Generally, the invention comprises the steps of: providing at least one mold of a desired shape or design having a cavity therein; filling the cavity with a UV curable material; and exposing the UV curable material to a UV light source of a sufficient intensity and for a sufficient time to cure the UV curable material to a solid mass contained in the cavity.

The mold may be made of any material suitable for the application. The mold is filled with UV curable material by a precision dispensing system. The mold may have an interior coating to prevent sticking of the UV material, once cured to a solid mass, to the inside of the mold and to facilitate release of the solid mass from the mold.

The UV curable material is limited in that it must transmit UV light, and therefore, cannot be opaque. The UV curable material may be pigmented or tinted. The UV curable material can be selected from a number of different UV curable polymer systems. A UV curable polymer system typically comprises 1-3% of a photoinitiators; 15-60% of reactive diluents, 25%-90% of an oligomer polymer; and 1-50% of additives and fillers. Polymers used in UV curable polymer systems can include polyurethanes, epoxies, polyesters and acrylates. Specific commonly used monomers for the polymer include N-vinylpyrrolidone, hydroxyethylacrylate, (poly)ethyleneglycol diacrylate, trimethylol-propanetriacrylate, norbornylacrylate, and styrene. Another suitable polymer system is the thiol-ene polymer system (also known as mercaptoesters). Commercially available UV curable polymer systems include products from Master Bond, Inc., Hackensack, N.J., Tangent Industries, Winsted, Conn.; Daicel Chemical Industries, Ltd., Sakai Osaka Japan, and Ctech LLC, New Hartford, Conn. A suitable thiol-ene polymer system is available from Ctech, LLC. The preferred UV curable liquid is a product that when cured will have good optical qualities, as this is typically indicative of the finish and look desired in the method of the invention. These products are typically cured at ambient temperatures, or at temperatures at or below 100° C. using a UV light source. Typical cure times range from 5 seconds to 5 minutes depending upon the wave length and intensity of the UV light and the thickness being cured.

One preferred UV curable liquid is an acrylate formulation. One commercially available formulation that could be used in the invention is the Ctech 8166-4A formulation, which can be cured to a tack free surface with 5 minutes UV exposure at 100° C.

A preferred UV light source is a UV lamp providing a UV intensity of about 115 mW/cm2 at 365 nm. The UV light source desirably provides a broad range of wavelengths from 250-500 nm, which will cure materials much faster than if only the 365 nm radiation were delivered.

Another preferred UV curable liquid is thiol-ene polymer system. One commercially available formulation that might be used in the invention is the Ctech Hard Dome Coat formulation, which preferably is cured at a lower intensity UV light in the range of 30 mW/cm2 with 5 minutes UV exposure at 100° C.

Additional components may optionally be incorporated into the UV curable material. These ingredients include, but are not limited to particles of cloth, wood, or newspaper, metal flakes, or the like. These ingredients may enhance the aesthetics and/or physical properties, such as strength, of the resulting molded article. The UV curable material may be tinted or pigmented to result in a translucent tinted article.

The design of the mold and cavity must allow for direct illumination of the UV curable material by the UV light source. This may be achieved by various means, such as providing an opening in the upper end of the mold to direct UV light into the mold cavity, so long as the light entering from the opening exposes all of the interior surfaces of the mold. In one embodiment of the present invention shown in FIG. 1, the mold 10 comprises two mold segments 12 and 14 with an opening 16 at the top of mold 10. The segments are closed together to form a cavity 20 that is filled with an UV curable material 22. A UV light source 24 shutters light through the opening to cure the UV curable material. The mold segments 12 and 14 are then separated to release the molded article or component as discussed hereafter. Multiple molds may be exposed to the same UV light source at the same time, therefore allowing curing of multiple molded components at once.

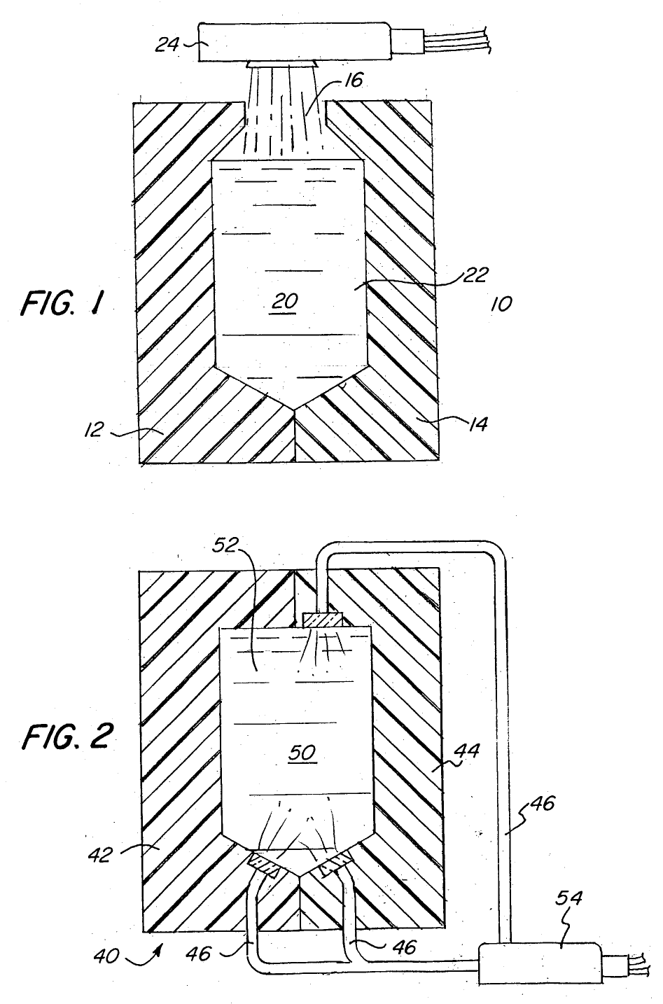

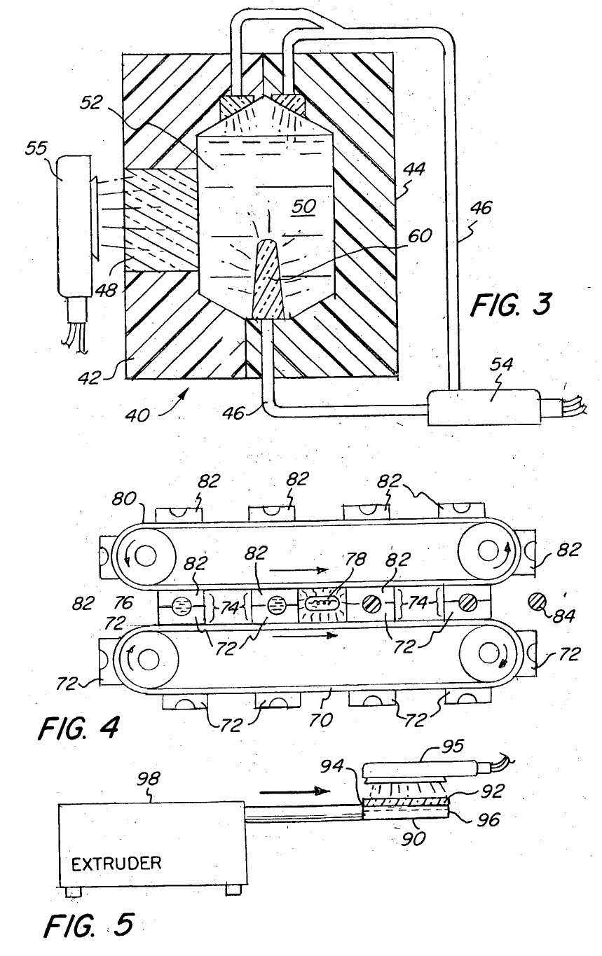

In an alternative embodiment shown in FIGS. 2 and 3, the mold 40 need not have an opening and UV light may be introduced into the cavity 50 through the walls of the mold 40 segments 42 and 44. The UV light can be provided by a UV light source 54 positioned to irradiate all of the cavity with UV light; or there can be multiple UV light sources 54 positioned to irradiate the cavity with UV light. A fiber optic or other light transmitting system 46 may be disposed in the mold itself to pass light into the cavity 50 of the mold 40 to illuminate the cavity 50. In the case of a larger mold, it may be desirable to have UV light is provided to the cavity by UV light transmission through a plurality of optical fibers 46 positioned to deliver UV light to a plurality of positions in the mold as shown in FIGS. 2 and 3.

As shown in FIG. 3, the mold 40 itself may be made, at least in part, of a UV transmissible material so light from UV lamp 55 on the exterior of the mold will be transmitted through the mold 40. In one potential embodiment, the entire mold may be made of a UV transmissible material. Illumination of the UV material within the mold 40 is achieved in the various embodiments described herein. Mold 40 in FIG. 3 comprises a plurality of mold segments 42 and 44 which are positioned and collapsed together to render the desired cavity shape and/or configuration for injecting and curing the UV curable material, i.e., vertical or horizontal molding. At least one of the mold segments 42 is made of UV transmissible material to allow for illumination of the cavity; alternatively, the mold segment has a “window” 48 through which UV light is introduced. The cavity is filled with UV curable material 52, by suitable means such as injection and the like, and exposed to UV light source through the window 48 made of UV transmissible material. In this embodiment, as an opening in the mold need not be provided to allow UV light illumination, the shape and design possibilities of the article or component increase and a cored or threaded article or component may easily be produced.

In another embodiment shown in FIG. 4, simultaneous manufacturing of multiple molded articles is provided by two conveyors 70 and 80 positioned horizontally and parallel to each other are provided, moving in the same direction at a desired speed. Mold segments 72 and 82 are placed on both conveyors so that they travel down one side and back the other, aligned as pairs with segments on the opposite conveyor. As each segment 72 travels down one conveyor 70, it interlocks with a segment 82 on the other parallel conveyor 80, forming a mold 74 having a cavity. The mold 74 travels beneath a filling station 76 which dispenses a UV curable material into the mold cavity. As the mold 74 continues to travel along the conveyor belt, the cavity is then exposed to a UV light source 78 to cause curing. As the mold continues to the end of the conveyors, the cured article or component 84 is released from the cavity as the segments 72 and 82 separate from one another. The article may drop into bulk as finished product or be transferred to the next manufacturing step.

In any of the previously discussed embodiments, a core 60 may also be included in the mold to form hollow articles and/or articles with shaped internal chambers as shown in FIG. 3. In such instances, the core 60 must be made from a material capable of transmitting UV light so as to allow for cure of the UV curable material within the cavity. A UV transmittable core 60 allows UV light to transmit through the core 60 and cure potentially blocked or shaded areas of the mold. In one potential embodiment, the core has a UV light source (including for example, a fiber optic output) embedded in the core to provide UV curing within the mold.

The core 60 may also be a collapsible core that can be provided in the mold in an expanded or inflated state. Such a collapsible core could be made of a flexible polymeric material or a series of interfitting parts. After the article or component is cured, the core 60 is collapsed or deflated so that it is smaller than the entry point and can be removed from within the molded article. The collapsible core would be designed to form the desired internal geometry of the resulting article. An article, such as a bottle, could be manufactured using this method with the advantage of the ability to decorate or stamp the bottle prior to removal of the collapsible core.

Referring now to FIG. 5, Another aspect of the present invention is a method of forming an extruded product using a UV curable liquid. The extrusion method of the present method involves providing a die 90 of a desired configuration with a UV transmissible wall 92 (for example, a top plate), an entry aperture 94, and a discharge end 96. A UV curable material is injected into the die through the entry aperture using injection molding machine 98. The UV transmissible wall 92 is illuminated with UV light source 95 of sufficient intensity and for a sufficient period to cure the UV curable material. Pressure from the injection molding machine 98 is applied to the UV curable material causing it to exit the die as a solid mass through the die discharge end 96. Optionally, a mechanism may be provided to remove the cured article from the discharge end.

The present invention is expected to provide a method and system which will provide substantial improvements in manufacturing molded articles, including: (1) improved energy efficiency due to the elimination of requirements for mold heating and cooling of molds as is typically required of injection molding methods; (2) improved capital cost because the method allows zero pressure molding, thus eliminating the need for high strength steel molds, and allowing use of molds which are made of less expensive materials and which are less expensive to fabricate; (3) improved operating cost by reducing material waste and providing greater manufacturing flexibility.

While UV cure resins have been used to form coatings and adhesives, they have not generally been used in molding applications. UV cure technology is an efficient means of molding materials as it involves low energy consumption. Productivity is improved as exposure to mere seconds of UV light initiates cure. Unlike other molding processes, UV cure technology is environmentally-friendly as it does not require use solvents. It does not require the heating and cooling or applying pressure to mold the material. This results in a minimal cavity space and increased gate size. As temperature is controlled, molds may be made from a wider variety of substrates, including heat sensitive materials, and is not limited to high strength steels. Additionally, there is no shrinking, warping or occurrence of voids as in traditional molding processes. Therefore, molding of UV curable material is ideal for manufacturing articles or components of an aesthetic nature.

It is to be appreciated that the foregoing is illustrative and not limiting of the invention, and that various changes and modifications to the preferred embodiments described above will be apparent to those skilled in the art. Such changes and modifications can be made without departing from the spirit and scope of the present invention, and it is therefore intended that such changes and modifications be covered by the following claims.

What is claimed is:

1. A method of manufacturing a molded article, comprising the steps of:
providing a mold at least substantially enclosing a cavity therein;
filling said cavity with a UV curable material;
exposing said UV curable material to UV light of a sufficient intensity and for a sufficient time to cure said UV curable material to a solid mass contained in said cavity.

2. The method of claim 1, wherein said mold comprises a plurality of mold segments which fit together to form said cavity.

3. The method of claim 2, wherein said plurality of mold segments form an opening in an upper portion of said mold.

4. The method of claim 2, wherein at least a portion of said mold comprises a UV transmissible material.

5. The method of claim 4, wherein said UV transmissible material is provided in at least one said mold segment.

6. The method of claim 1 wherein said UV light is provided by a UV light source positioned to irradiate all of said cavity with UV light.

7. The method of claim 1, wherein said UV light is provided by multiple UV light sources positioned to irradiate all of said cavity with UV light.

8. The method of claim 6, wherein said UV light is provided to said cavity by a UV light transmission through one or more optical fibers.

9. The method of claim 6, wherein said UV light is provided to said cavity by a UV light transmission through a plurality of optical fibers positioned to deliver UV light to a plurality of positions in said mold.

10. The method of claim 1, wherein said mold has a core disposed within said cavity.

11. The method of claim 10, wherein said core is collapsible.

12. The method of claim 10, wherein said core is formed of a UV transmittable material.

13. The method of claim 2, wherein said mold segments are first fitted together to form said cavity, and said cavity is then filled with said UV curable material, and said UV curable material is then exposed to UV light, and said mold segments are separated to release said solid mass from said cavity.

14. The method of claim 2, wherein said mold segments are mounted to a conveying system moving said mold segments from a mold filling station to a UV curing zone to a mold unloading station.

15. A method of manufacturing a molded article, comprising the steps of:
providing a plurality of mold segments fitted together to form a mold having a cavity therein, said cavity having an opening in an upper end thereof;
filling said cavity with a UV curable material;
radiating said UV curable material with UV light of a sufficient intensity and for a sufficient time to cure said UV curable material to a solid mass contained in said cavity, said UV light being directed into said cavity through said opening;
separating said mold segments from each other;
removing said solid mass from said cavity.

16. The method of claim 15, wherein said mold has a core disposed within said cavity.

17. The method of claim 16, wherein said core is collapsible.

18. The method of claim 16, wherein said core is formed of a UV transmittable material.

19. The method of claim 15 wherein said UV light is provided by a UV-light source positioned to irradiate all of said cavity with UV light.

20. The method of claim 15, wherein said UV light is provided by multiple UV light sources positioned to irradiate all of said cavity with UV light.

21. A method of manufacturing a molded article, comprising the steps of:
providing a plurality of mold segments fitted together to form a mold having a cavity therein, at least a portion of at least one of said mold segments being formed of a UV transmissible material;
filling said cavity with a UV curable material;
radiating said UV curable material with UV light of a sufficient intensity and for a sufficient time to cure said UV curable material to a solid mass contained in said cavity, said UV light being directed into said cavity through said opening;
separating said mold segments from each other;
removing said solid mass from said cavity.

22. The method of claim 21 wherein said UV light is provided by a UV light source positioned to irradiate all of said cavity with UV light.

23. The method of claim 21, wherein said UV light is provided by multiple UV light sources positioned to irradiate all of said cavity with UV light.

24. The method of claim 21, wherein said UV light is provided to said cavity by a UV light transmission through one or more optical fibers.

25. The method of claim 23, wherein said UV light is provided to said cavity by a UV light transmission through a plurality of optical fibers positioned to deliver UV light to a plurality of positions in said mold.

26. The method of claim 21, wherein said mold has a core disposed within said cavity.

27. The method of claim 26, wherein said core is collapsible.

28. The method of claim 26, wherein said core is formed of a UV transmittable material.

29. A method of manufacturing an extruded article, comprising the steps of:
providing a die having a UV transmissible wall, an entry aperture, and a discharge end;
injecting a UV curable material into said die through said entry aperture;
illuminating said UV transmissible wall with UV light; and
applying pressure to said UV curable material causing it to exit said die as a solid mass through said discharge end.

30. The method of claim 29, further comprising providing a mechanism to remove said solid mass from said discharge end.

31. A molding system for manufacturing a molded articles, comprising:
a UV light source;
at least one mold having a cavity therein; said mold having means for illumination of said cavity with UV light from said UV light source;
means for dispensing a UV curable material into said cavity.

32. The molding system of claim 31, wherein said mold comprises a plurality of mold segments which fit together to form said mold and cavity.

33. The molding system of claim 32, wherein said plurality of mold segments form an opening in an upper portion of said mold.

34. The molding system of claim 32, wherein at least a portion of said mold comprises a UV transmissible material.

35. The molding system of claim 34, wherein said UV transmissible material is provided in at least one said mold segment.

36. The molding system of claim 31, wherein said UV light is provided to said cavity by a UV light transmission through one or more optical fibers positioned to deliver UV light to one or more positions in said mold.

37. The molding system of claim 31, wherein said mold has a core disposed within said cavity, said core being formed of a UV transmittable material.

38. The molding system of claim 32, wherein said mold segments are mounted to a conveying system moving said mold segments from a mold filling station to a UV curing zone to a mold unloading station.
